(19) United States
(12) Patent Application Publication
(10) Pub. No.: US 2004/0135349 A1
(43) Pub. Date: Jul. 15, 2004

(54) Method and apparatus for multi-purpose trailer

(76) Inventor: John M. Palmer, Cicero, NY (US)

Correspondence Address: HANCOCK & ESTABROOK, LLP, 1500 MONY TOWER I, PO BOX 4976, SYRACUSE, NY, 13221-4976, US

(21) Appl. No.: 10/717,227

(22) Filed: Nov. 19, 2003

Related U.S. Application Data
(63) Continuation-in-part of application No. 09/902,191, filed on Jul. 10, 2001, now abandoned.
(60) Provisional application No. 60/218,211, filed on Jul. 14, 2000.

(51) Int. Cl. B60D 1/00

(52) U.S. Cl. 280/656

(57) ABSTRACT

A lightweight multipurpose trailer which separates into two parts includes a base chassis and cargo deck. The base chassis provides the hitch beam, axles, suspension, and wheels, but the chassis alone does not have the necessary structure or strength to carry a load without the addition of the cargo deck. The attached cargo deck provides the required strength and rigidity through its connections directly to the axle and the hitch beam. Different customized cargo support decks each fit on the base chassis, but can be stored separately with or without their cargo.

### CROSS-REFERENCE TO RELATED APPLICATIONS

The present application claims priority from U.S. Provisional Application Serial No. 60/218,211 filed Jul. 14, 2000 entitled MULTIPLE USE TRAILER and from U.S. application Ser. No. 09/902,191 filed Jul. 10, 2001 and entitled MULTI-PURPOSE TRAILER, each of which is incorporated herein by reference.

### FIELD OF THE INVENTION

This invention relates generally to the field of utility trailers, and more particularly to a utility trailer system with an easily removable bed.

### BACKGROUND OF THE INVENTION

A trailer, towed behind a vehicle, is a common item used to transport recreational vehicles, such as snowmobiles, boats, jet skis, motorcycles, and the like. These vehicles are too big to fit into today's smaller cars, but they are not too heavy to tow with the small car as long as the trailer is lightweight. Many people are forced into either purchasing several complete trailers specialized to carry a particular recreational vehicle, or purchasing a large sport-utility vehicle or truck to pull a heavy trailer that may haul a variety of objects. Either of these possibilities places an increased demand on storage space and fuel usage. A consumer may save a significant amount of space and fuel by eliminating the need for a large vehicle, and eliminating the need for multiple sets of axles, wheels, and trailer tongues. Consequently, a lightweight multipurpose trailer having a changeable cargo deck is needed to transport and store the hobby vehicles without adding unnecessary parts and weight.

The prior art teaches several types of trailer systems having changeable cargo containers or decks. Most systems consist of a trailer that is functional in itself for hauling some type of cargo without any type of added structure. Others have a heavy structural main frame that has a correspondingly cumbersome system of moving the heavy cargo containers on an off the main frame. These systems work well for their intended purpose of hauling heavy cargo such as cars, horses, or heavy equipment, but they are inefficient for the transport of light cargo.

### SUMMARY OF THE INVENTION

Briefly stated, a lightweight multipurpose trailer particularly designed to separate into two parts, a base chassis and cargo support deck. The base chassis provides the hitch beam, axles, suspension, and wheels, but the chassis does not have the necessary structure or strength to carry a load without the addition of the cargo support deck. The attached cargo support deck provides the required strength and rigidity through its connections directly to the axle and the hitch beam. Different customized cargo support decks each fit on the base chassis, but can be stored separately with or without their cargo.

According to an embodiment of the invention, a multipurpose trailer system includes a chassis, the chassis including at least one axle and only one main beam, the axle including first and second ends; a first suspension attached to the first end of the axle, and a second suspension attached to the second end of the axle; a first wheel attached to the first suspension, and a second wheel attached to the second suspension; the axle having first, second and third axle portions, the first axle portion extending from the first end of the axle to the third axle portion, the second axle portion extending from the second end of the axle to the third axle portion; the main beam attached to a center of the axle on the third axle portion; and a cargo deck including at least first, second, and third connectors for removably mounting the cargo deck to the chassis, the first and second connectors mounted on the axle and/or the cargo deck, the third connector mounted on the beam and/or the cargo deck; wherein the cargo deck provides structural rigidity to the chassis through the first, second and third connectors, the structural rigidity being required to transport a load or a cargo from a first location to a second location.

According to an embodiment of the invention, a multipurpose trailer system includes deck means for locating and positioning cargo; moving means for transporting the deck means from a first location to a second location when the moving means is connected to a prime mover; and attachment means for removably attaching the deck means to the moving means; wherein the securing means being attached to the moving means by the attachment means provides lateral strength required by the moving means to carry the cargo from the first location to the second location without the chassis bending or failing.

According to an embodiment of the invention, a method of making a multipurpose trailer system includes the steps of (a) providing an axle with a first and second ends and first, second and third portions, the first portion extending from the first end of the axle to the third axle portion, and the second axle portion extending from the second end of the axle to the third portion; (b) connecting a main beam to the third portion a center of the axle, wherein the main beam and the axle in combination are not sufficiently rigid to transport cargo from a first location to a second location; (d) connecting a first suspension to the first portion of the axle, and connecting a second suspension to the second portion of the axle; (e) connecting a first wheel to the first suspension, and connecting a second wheel to the second suspension; (f) providing a cargo deck with a front side and a back side;, the front side positioned near the main beam, the back side located opposite the front side, the cargo deck with sufficient rigidity to transport cargo from the first location to the second location; (g) removably attaching the cargo deck to the first and second portions of the axle; and (h) removably attaching the front side of the cargo deck to the main beam, wherein steps (g) and (h) impart to the cargo deck sufficient rigidity wherein cargo is transportable via the trailer system from a first location to a second location.

### BRIEF DESCRIPTION OF THE DRAWINGS

FIG. 1 shows a perspective view of a first embodiment of the chassis of the present invention.

FIG. 2 shows a perspective view of a second embodiment of the chassis of the present invention.

FIG. 3 shows a perspective view of a cargo support deck positioned in spaced relation to the chassis of FIG. 2.

FIG. 4 shows a fragmentary perspective view of the mounting structure of the chassis and cargo deck of the present invention.

FIG. 5 shows a perspective view of the cargo support deck support/storage device.

### DETAILED DESCRIPTION OF THE PREFERRED EMBODIMENT

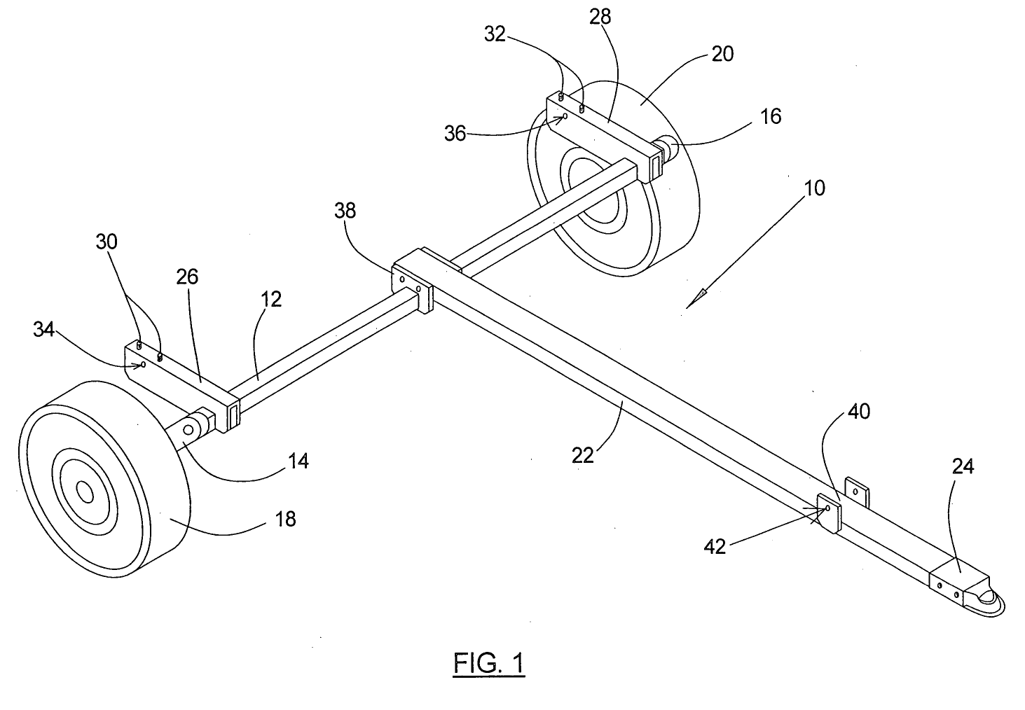

Referring to FIG. 1, a base chassis 10 generally includes an axle 12 having a conventional suspension systems 14, 16, such as leaf springs (not shown) or a torsion beam and lever arm system (shown), attached to its opposing ends, wheels 18, 20 rotatably attached to suspension systems 14, 16, respectively, a main beam 22 attached to and extending forwardly from the center of axle 12 at connection 38, a towing hitch 24 attached to the forward end of beam 22, a pair of brackets 26, 28 attached to axle 12 adjacent each suspension system 14, 16, respectively, two pairs of dowel pins 30, 32 attached to brackets 26, 28, respectively, a pair of holes 34, 36 through brackets 26, 28, respectively, and a mounting bracket 40 attached to beam 22 at an intermediate position therealong, with a hole 42 formed through bracket 40. Axle 12, connection 38 and beam 22 are sized primarily to withstand the torsional stress generated by suspension systems 14, 16 with the weight of axle 12, connection 40, and beam 22. Additional torsional loads generated by suspension systems 14, 16 when a cargo deck is attached are cancelled by brackets 26, 28. Connection 40 is sized to withstand the force required to turn chassis 10 without any additional cargo. Beam 22 is sized to withstand the axial force required to pull both chassis 10 and any cargo deck attached. Any loads in addition to those created by the weight of chassis 10 when no cargo deck is attached may cause axle 12, connection 40, and/or beam 22 to bend or fail.

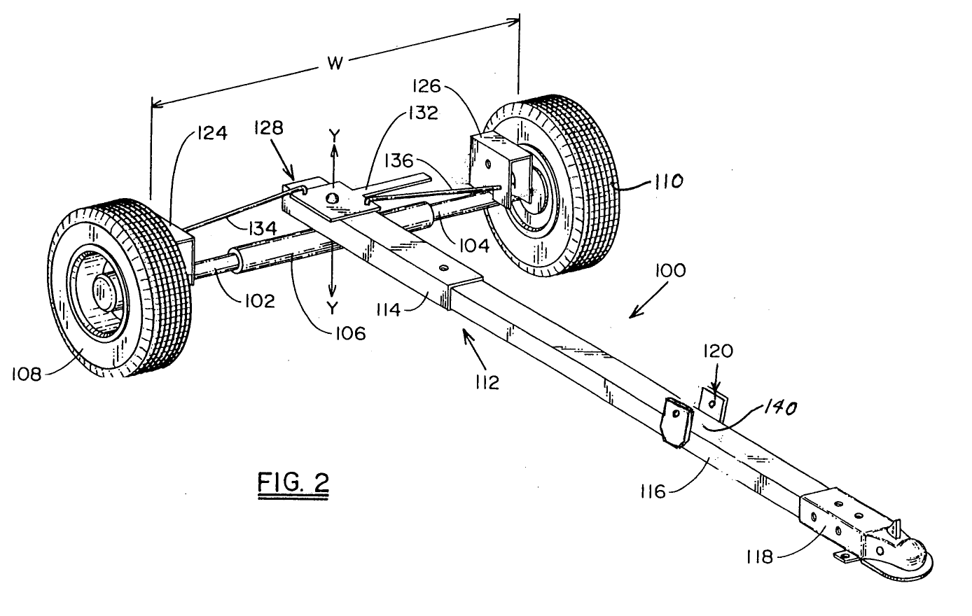

Referring to FIG. 2, an alternate embodiment of the base chassis of the present invention is illustrated. Chassis 100 generally includes a pair of axles 102, 104 that telescopically engage the opposing ends of an inner axle member 106, and which include a pair of wheels 108, 110 rotatably connected thereto with a traditional suspension, and a beam assembly, designated generally by reference numeral 112. Beam assembly 112 includes a tubular member 114 attached to and extending forwardly from inner axle member 106, and a beam member 116 telescopically engaged with and extending forwardly from tubular member 114. Beam member 116 includes a towing hitch 118 attached to its forward end, and a mounting bracket 120 attached an intermediate position therealong. A conventional fastener 122, such as a pin, interconnects tubular member 114 and beam member 116.

Base chassis 100 further includes a pair of mounting brackets 124, 126 attached to axles 102, 104, respectively, and a width adjustment assembly, designated generally by reference numeral 128, of which inner axle member 106 forms a part thereof. Width adjustment assembly 128 further includes a plate 130 mounted to the upper surface of tubular member 114 for rotation about its central, vertical axis Y-Y, an arm 132 extending outwardly from plate 130, and a pair of mechanical linkages 134, 136 extending between and interconnecting plate 130 (linkages 134, 136 are connected to diagonally opposite corners of plate 130) to mounting brackets 124, 126, respectively. A user may grasp arm 132 and rotate it either clockwise or counter-clockwise, thereby causing linkages 134, 136 to either decrease or increase the effective width W of base chassis 100.

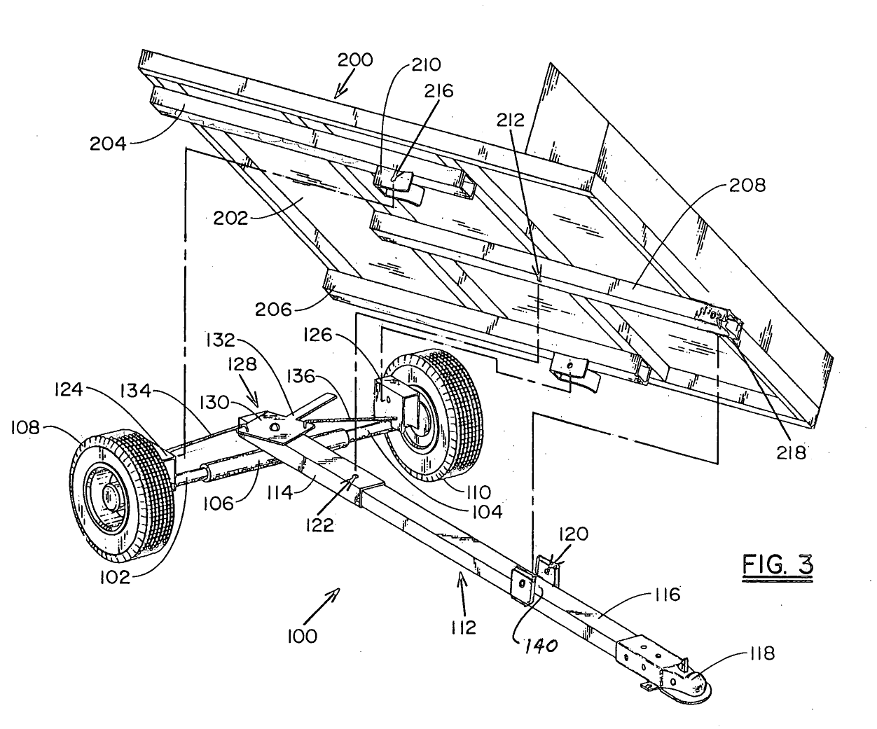

Referring to FIG. 3, a cargo deck 200 may be interconnected to chassis 10 or 100. It should be noted that FIG. 3 illustrates deck 200 being connected to chassis 100, but it could also be attached to chassis 10 in the same manner. Deck 200 includes a bottom surface 202, a pair of joists 204, 206 attached to bottom surface 202 and extending parallel to the longitudinal axis of deck 200 adjacent opposing sides thereof, and a centrally extending joist 208 attached to bottom surface 202. Mounting tabs 210, 212 are attached to joists 204, 206, respectively, while hole 218 is formed through the forward end of joist 208. To interconnect deck 200 to chassis 100 (or chassis 10), a user positions mounting tabs 210, 212 in engaging relation to mounting brackets 124, 126 (or mounting brackets 26, 28), respectively, and joist 208 in engaging relation to mounting bracket (or mounting bracket 40). Mounting hole 218 formed through joist 208 and mounting hole 120 formed through bracket 140 should be axially aligned such that conventional fasteners, such as pins, may be used to securely connect deck 200 to beam 116 (or beam 22).

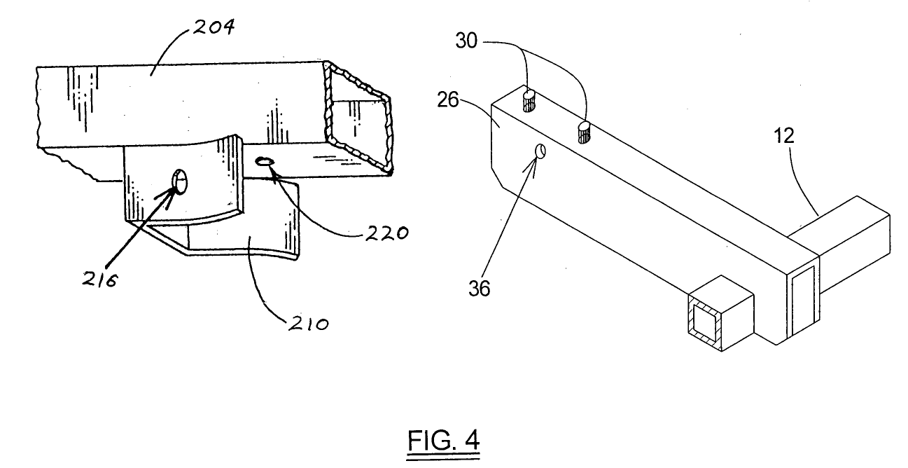

Referring to FIG. 4, holes 216, 34 formed through mounting tab 210 (and 212) and mounting bracket 26 (and 28), respectively, should be axially aligned, while dowel pins 30 axially engage with holes 220 formed in joist 204, so that conventional fasteners, such as pins, may be used to securely interconnect deck 200 to axle 12 (or axles 102. 104).

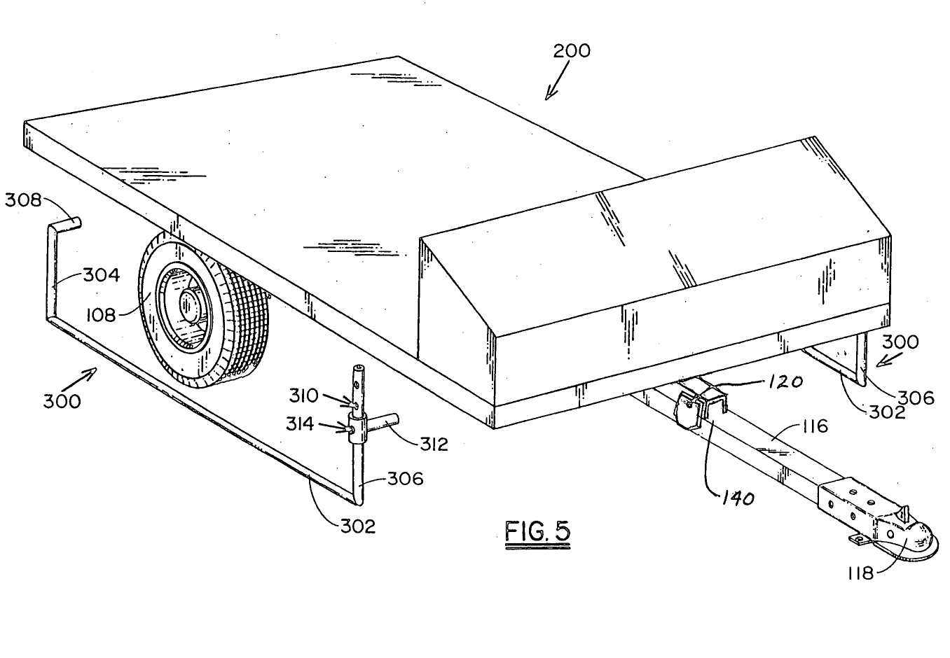

Referring to FIG. 5, a cargo deck support, designated generally by reference numeral 300, is shown with a pair of supports 300 needed to support a cargo deck. Support 300 generally includes a U-shaped body having a medial portion 302 and a pair of legs 304, 306 extending in parallel relation to one another and outward perpendicular from opposing ends of medial portion 302. Leg 304 includes an arm 308 extending outward perpendicular from its free terminal end, and leg 306 includes a series of longitudinally spaced, axially aligned pairs of holes 310 formed therethrough adjacent its free terminal end. An arm 312 is movably and securely interconnected to leg 306 via pin 314, extending in perpendicular relation to arm 306 and in parallel relation to arm 308.

Support 300 is used to hold cargo deck 200 (typically with cargo positioned thereon) in a stored location while giving the owner use of chassis 10 (or 100, for convenience only chassis 10 is referred to hereafter) to move other cargo decks. To store a cargo deck 200, the user moves chassis 10 with deck 200 thereon to the desired storage location. A conventional jack, or other hoisting device, is then be attached to or positioned under the forward end of chassis 10. The jack is lowered to a predetermined distance off the ground. The user then disconnects deck 200 from mounts 26, 28 on chassis 10. The user then positions a support 300 under each of the side edges of chassis 10 with medial portion 302 engaging the ground and legs 304, 306 extending vertically upwardly therefrom. This step and the following steps are done to each of the two supports 300. The user then uses the jack or hoisting device to raise the front of chassis 10 to a predetermined distance off the ground. Arm 312 is then vertically adjusted, if necessary, to engage bottom surface 202 of deck 200, after which the user disconnects beam 22 from deck 200 and lowers chassis 10 from deck 200, thereby leaving deck 200 resting on supports 300. Chassis 10 may then be moved either forward or rearward from beneath deck 200, and then used to carry another deck 200, typically with a different cargo, such as a snowmobile instead of an ATV.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A multipurpose trailer system, comprising:
a chassis, said chassis including at least one axle and only one main beam, said axle including first and second ends;
a first suspension attached to said first end of said axle, and a second suspension attached to said second end of said axle;
a first wheel attached to said first suspension, and a second wheel attached to said second suspension;
said axle having first, second and third axle portions, said first axle portion extending from said first end of said axle to said third axle portion, said second axle portion extending from said second end of said axle to said third axle portion;
said main beam attached to a center of said axle on said third axle portion; and
a cargo deck including at least first, second, and third connectors for removably mounting said cargo deck to said chassis, said first and second connectors mounted on one of said axle and said cargo deck with said third connector mounted on one of said beam and said cargo deck;
wherein said cargo deck provides structural rigidity to said chassis through said first, second and third connectors, said structural rigidity being required to transport a load or a cargo from a first location to a second location.

2. A multipurpose trailer system as in claim 1, further comprising lifting means, attached to said main beam, for pivoting said chassis about said wheels and lifting said cargo deck from said chassis.

3. A multipurpose trailer system as in claim 2, further comprising stationary support means, removably attached to said cargo deck, for supporting said cargo deck when said chassis is unattached from said cargo deck.

4. A multipurpose trailer system as in claim 2, further comprising a plurality of indicator lights attached to said axle.

5. A multipurpose trailer system as in claim 1, wherein said first and second connectors have first and second portions, said first portions of said first and second connectors being mounted to said axle and said second portion of said first and second connectors being mounted to said cargo deck.

6. A multipurpose trailer system as in claim 5, wherein said third connector has first and second portions, said first portion of said third connector being mounted to said main beam and said second portion of said third connector being mounted to said cargo deck.

7. A multipurpose trailer system as in claim 5, further comprising lifting means, attached to said main beam, for pivoting said chassis about said wheels and lifting said cargo deck from said chassis.

8. A multipurpose trailer system as in claim 1, further comprising stationary support means, removably attached to said cargo deck, for supporting said cargo deck when said chassis is unattached from said cargo deck.

9. A multipurpose trailer system as in claim 8, wherein said first and second connectors each have first and second portions, said first portions of said first and second connectors being mounted to said axle and said second portion of said first and second connectors being mounted to said cargo deck.

10. A multipurpose trailer system as in claim 8, wherein said third connector includes a first portion and a second portion, said first portion of said third connector being mounted to said beam and said second portion of said third connector being mounted to said cargo deck.

11. A multipurpose trailer system, comprising:
deck means for locating and positioning cargo;
moving means for transporting said deck means from a first location to a second location when said moving means is connected to a prime mover; and
attachment means for removably attaching said deck means to said moving means;
wherein said securing means being attached to said moving means by said attachment means provides lateral strength required by said moving means to carry said cargo from said first location to said second location without the chassis bending or failing.

12. A method of making a multipurpose trailer system, comprising the steps of:
(a) providing an axle with first and second ends and first, second and third portions, said first portion extending from said first end of said axle to said third portion, and said second portion extending from said second end of said axle to said third portion;
(b) connecting a main beam to said third portion of said axle, wherein said main beam and said axle in combination are not sufficiently rigid to transport cargo from a first location to a second location;
(d) connecting a first suspension to said first portion of said axle, and connecting a second suspension to said second portion of said axle;
(e) connecting a first wheel to said first suspension, and connecting a second wheel to said second suspension;
(f) providing a cargo deck with a front side and a back side; (g) removably attaching said cargo deck to said first and second portions of said axle; and
(h) removably attaching said front side of said cargo deck to said main beam, wherein steps (g) and (h) impart to said cargo deck sufficient rigidity wherein cargo is transportable via said trailer system from a first location to a second location.

13. A method as in claim 12, further comprising the steps of:
providing a stationary support structure connectable to support said cargo deck;
connecting said stationary support structure to said cargo deck; and
supporting said cargo deck with said stationary support after said axle and beam are unattached from said cargo deck.

14. A method as in claim 13, wherein said support structure includes a plurality of individual legs; and said step of connecting includes:
attaching at least two of said legs to said back side of said cargo deck; and
attaching at least two of said legs to said front side of said cargo deck.

15. A method as in claim 13, wherein said support structure includes two support members, said support members having first and second ends, first and second legs each having free terminal ends and extending outward perpendicular from said first and second ends, respectively, said first and second ends extending in parallel relation to one another; and said step of connecting includes:
providing first and second attachment members attached to said first and second legs respectively, wherein said first arm is rigidly attached to said free terminal end of said first leg, and said second arm is adjustably connected to said second leg;
attaching said first arms of both support members to said back side of said cargo deck; and
attaching said second arms of both support members to said front side of said cargo deck.

16. A method as in claim 13, wherein said support structure includes two support members, said support members having first and second ends, first and second legs each having free, terminal ends and extending perpendicular outwardly from said first and second ends, respectively, said first and second ends extend in parallel relation to one another; and said step of connecting includes:
providing first and second attachment members attached to said first and second legs respectively, wherein said first arm and said second arms are rigidly attached to said free terminal end of said first and second legs, respectively;
attaching said first and said second arm of one support member to said front side of said deck; and
attaching said first and said second arm of one support member to said back side of said deck.
